(19) United States
(12) Patent Application Publication
(10) Pub. No.: US 2026/0349855 A1
(43) Pub. Date: Nov. 5, 2026

(54) SYSTEMS AND METHODS FOR SUMMARIZING DATA RELATED TO MESSAGE QUEUES

(71) Applicant: JPMorgan Chase Bank, N.A., New York, NY (US)

(72) Inventors: Debabrata Ghosh, Mckinney, TX (US); Joseph Marsh, Poughkeepsie, NY (US); Christopher Cavalleri, Poughkeepsie, NY (US); Ovidio Ruiz, Wharton, NJ (US); Jessica Shabet, Denville, NJ (US); Anthony Iannolo, Syosset, NY (US); Paul J. Mottola, McKinney, TX (US); Andy Cruikshank, Marysville, OH (US); Robert A. Anderson, Powell, OH (US)

(21) Appl. No.: 19/197,399

(22) Filed: May 2, 2025

(51) Int. Cl. G06F 9/54; H04L 67/61

(52) U.S. Cl. CPC G06F 9/546; H04L 67/61; G06F 2209/548

(57) ABSTRACT

Examples described herein provide a system including at least one memory designed with a bidirectional dual address space having a first and second address space, and at least one processor in communication with the at least one memory. The at least one processor is designed to connect to a queue manager of a messaging system via the first address space and receive data associated with a plurality of messages in at least one message queue of the queue manager at the second address space. The at least one processor is further designed to generate at least one record summary for each of at least a subset of the plurality of messages in the second address space and store the at least one record summary. An amount of data stored for the at least one record summary is less than a total amount of data associated with the plurality of messages.

### TECHNICAL FIELD

The present disclosure relates to monitoring operation of one or more message queues in a messaging system. More particularly, the examples of the present disclosure relate to retrieving and processing data associated with messages in at least one message queue.

### BACKGROUND

Message queueing services facilitate secure and asynchronous communication between applications in, for example, an enterprise system or organization. One or more queues in a messaging system may be associated with respective clients or groups within an organization. Client devices in these administrative groups may perform cross-application operations or communications by putting messages to corresponding message queues, for example, using one or more application programming interfaces (APIs).

Messaging systems may generate large quantities of data related to messages in respective message queues. Examples of related data may include system performance and activity monitoring records associated with respective operations, messages, message queues, queue managers, or other modules in the messaging system. Administrative users in an organization may rely on these records to track and compare message queue usage across different groups or clients. For example, administrative users may track a number or proportion of queue operations performed by respective groups, computer processing unit (CPU) usage by respective groups, or errors encountered by respective groups.

A single message queue operation typically causes the messaging system to generate a large amount of system performance and activity monitoring records. For example, a messaging system may generate tens of thousands of records per second. As a result, the process of analyzing these records by system administrators is both extremely time-consuming and error prone. For example, data from these records are typically output to a continuously updated log file. If a system administrator is notified of a malfunction in the messaging system (e.g., a channel is down), the system administrator often must scan through thousands of lines from the log file to pinpoint the issue. Further, long-term storage of these records is not feasible due to the sheer amount of data generated by the messaging system per second.

### SUMMARY

Examples provide a system including at least one memory designed with a bidirectional dual address space and storing processor-executable code and at least one processor in communication with the at least one memory. The at least one processor is designed to execute the code to cause the system to connect to a queue manager of a messaging system via a first address space of the bidirectional dual address space and receive data associated with a plurality of messages in at least one message queue of the queue manager at a second address space of the bidirectional dual address space. The at least one processor is further designed to execute the code to cause the system to generate at least one record summary for each of at least a subset of the plurality of messages in the second address space and store the at least one record summary in the at least one memory. An amount of data stored for the at least one record summary is less than a total amount of data associated with the plurality of messages.

In some aspects, the at least one processor is further designed to execute the code to cause the system to generate the at least one record summary such that the at least one record summary indicates a proportion of operations performed using respective queues of the at least one message queue over a predetermined time interval. In further aspects, the at least one record summary further indicates at least one of a maximum computer processing unit (CPU) utilization of the at least one message queue, a minimum CPU utilization of the at least one message queue, an average CPU utilization of the at least one message queue over the predetermined time interval, or combinations thereof.

In other aspects, the at least one processor is designed to execute the code to cause the system to receive the data associated with a plurality of messages in the at least one message queue of the queue manager by connecting to an in-memory resource via the second address space. The data associated with the plurality of messages includes system performance and activity monitoring records associated with the plurality of messages.

In some examples, the at least one processor designed to execute the code to cause the system to generate the at least one record summary for a respective subset of the plurality of messages is further designed to extract, from respective system performance and activity monitoring records received via the second address space, at least one of a virtual storage identifier (ID) associated with the queue manager, a record source ID, a queue manager ID of the queue manager, a queue ID of the at least one message queue, an operation ID associated with the respective subset of the plurality of messages, a connection type associated with the respective subset of the plurality of messages, or combinations thereof.

In some aspects, the at least one record summary has a non-linear high indexing data structure. In further examples, the at least one processor is further designed to execute the code to cause the system to detect, via the first address space, an exception condition associated with the queue manager. The exception condition is based at least in part on at least one parameter related to the queue manager; and output a notification indicating the exception condition.

In other aspects, the at least one processor is further designed to execute the code to cause the system to scan a queue manager vector table for active queue managers in a virtual storage location. In some aspects, the at least one record summary indicates an operation payload and resource type for the subset of the plurality of messages.

Examples provide a method including connecting to a queue manager of a messaging system via a first address space of a bidirectional dual address space of a memory, receiving data associated with a plurality of messages in at least one message queue of the queue manager at a second address space of the bidirectional dual address space of the memory, and storing at least one record summary each for at least a subset of the plurality of messages in the second address space. An amount of data stored for the at least one record summary is less than a total amount of data associated.

In some aspects, the method further includes detecting, via the first address space, an exception condition associated with the queue manager. The exception condition is based at least in part on at least one parameter related to the queue manager; and outputting a notification indicating the exception condition.

In further aspects, the exception condition is triggered by at least one of the at least one message queue exceeding a utilization threshold, at least one channel mapping area associated with the queue manager being non-operational, or combinations thereof.

In some examples, the method further includes connecting to an in-memory resource via the second address space to receive the data associated with the plurality of messages in the at least one message queue of the queue manager. The data associated with the plurality of messages in the at least one message queue of the queue manager includes system performance and activity monitoring records associated with the plurality of messages.

In further examples, the method further includes outputting at least one blocking get command to the in-memory resource via the second address space to receive the system performance and activity monitoring records. In other aspects, the method further includes processing statistical data of the system performance and activity monitoring records via the second address space, and generating an alert based on the statistical data of the system performance and activity monitoring records.

In further aspects, the method further includes extracting, from respective system performance and activity monitoring records received via the second address space, at least one of a virtual storage identifier (ID) associated with the queue manager, a record source ID, a queue manager ID of the queue manager, a queue ID of the at least one message queue, an operation ID associated with the respective subset of the plurality of messages, a connection type associated with the respective subset of the plurality of messages, or a combination thereof.

In further examples, the method further includes generating the at least one record summary using data extracted from the system performance and activity monitoring records over a predetermined time interval. In other aspects, connecting to the queue manager via the first address space includes scanning, in a virtual storage location, a queue manager vector table for active queue managers. In some aspects, the at least one record summary has a non-linear high indexing data structure.

Examples also provide one or more non-transitory computer-readable storage media including instructions that, when executed by one or more processors, cause the one or more processors to perform a set of operations. The set of operations include connecting to a queue manager of a messaging system via a first address space of a bidirectional dual address space of a memory, receiving data associated with a plurality of messages in at least one message queue of the queue manager at a second address space of the bidirectional dual address space of the memory, and storing at least one record summary each for at least a subset of the plurality of messages in the second address space. An amount of data stored for the at least one record summary is less than a total amount of data associated.

### BRIEF DESCRIPTION OF THE DRAWINGS

FIG. 1 is a schematic of a network environment for a messaging system, according to a disclosed example;

FIG. 2 is a schematic block diagram of a computer system for summarizing data related to messages in a message queue, according to disclosed examples;

FIG. 3 is a diagram of a primary address space of a bidirectional dual address space, according to disclosed examples;

FIG. 4 is a diagram of a secondary address space of a bidirectional dual address space, according to disclosed examples;

FIG. 5 is workflow diagram for a system having a bidirectional dual address space, according to disclosed examples;

FIG. 6 is a swimlane diagram of a system for generating a record summary of data related to messages in at least one message queue, according to disclosed examples;

FIG. 7 is a swimlane diagram of a system for detecting an exception condition associated with a messaging system, according to disclosed examples;

FIG. 8 is a workflow diagram of a system for generating an example record summary of data related to messages in at least one message queue, according to a disclosed example; and

FIG. 9 is a flowchart of a method of generating a record summary of data related to messages in at least one message queue, according to disclosed examples.

### DETAILED DESCRIPTION

The present disclosure relates to techniques and systems that use a bidirectional dual address space to summarize data associated with messages in at least one message queue of a messaging system. For example, a primary address space of the bidirectional dual address space may be used to detect and connect to one or more queue managers of the messaging system, with each queue manager managing at least one message queue. The primary address space may also route system management address data of the messaging system to a secondary address space of the bidirectional dual address space, for example, via cross-memory communication. The secondary address space may then be used to receive the data associated with the messages and generate a record summary of the data such that the record summary requires significantly less storage than the data itself. By leveraging the bidirectional dual address space to receive and process the data associated with the messages, the system efficiently accesses and processes both data associated with the queue managers and data associated with the messages in the at least one message queue.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use examples of the disclosure. Various modifications to the illustrated examples will be readily apparent to those skilled in the art, and generic principles presented herein can be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosure. Skilled artisans will recognize the examples provided herein have many useful alternatives and fall within the scope of examples of the disclosure.

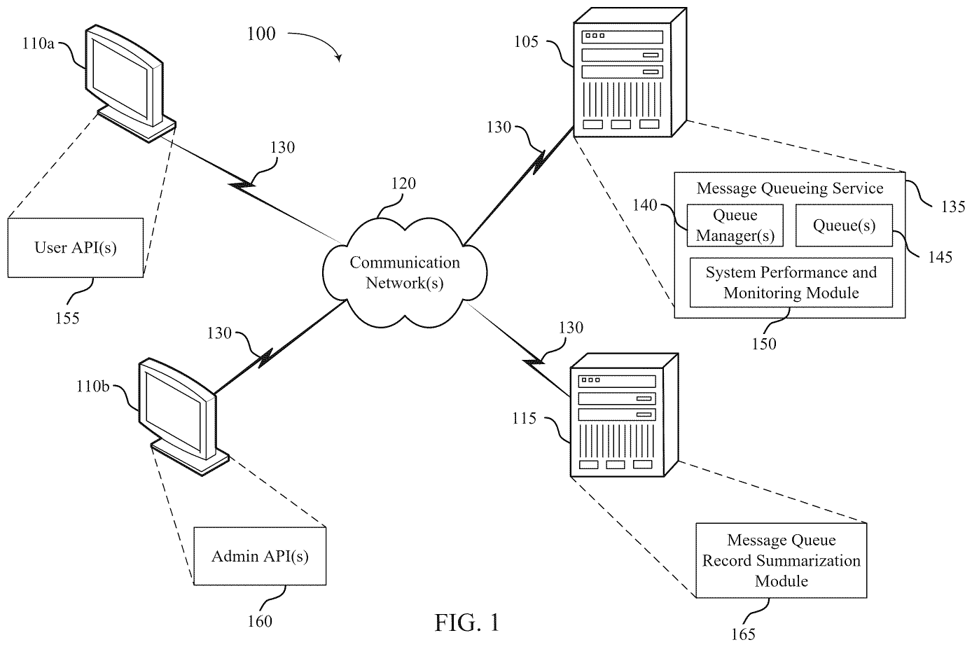

FIG. 1 is a schematic of an example network environment 100 for a messaging system. The network environment 100 may include a messaging system server 105, one or more user devices 110a and 110b (collectively referred to as user devices 110), a client server 115, and at least one communication network 120. The at least one communication network 120 may be in communication with the user devices 110 via one or more networks or communication links 130.

The messaging system server 105 may host a message queuing service 135 that includes one or more queue managers 140. Each queue manager 140 may manage at least one message queue 145 of a messaging system. The message queueing service 135 may be, for example, International Business Machines (IBM) MQ (also may be referred to as IBM WebSphere MQ or MQSeries), Amazon Simple Queue Service (SQS), Azure Service Bus, Google Cloud Pub/Sub, RabbitMQ, Apache ActiveMQ, or another suitable message queuing service. The messaging system server 105 may operate using a suitable operating system to support the message queueing service. As an example, a messaging system server 105 using IBM MQ may operate using an IBM z/OS operating system. In other examples, other types of operating systems may be used with the messaging system server 105.

The message queuing service 135 may also include a system performance and activity monitoring module 150 that may collect data related to messaging system jobs and performance, such as messaging system configurations, messaging system workloads, job and task information, metrics, resource utilization, or the like. In some instances, the system performance and activity monitoring module 150 may be incorporated with the operating system of the messaging system server 105.

A user device 110a may include one or more user application programming interfaces (APIs) 155 that facilitate communication between the user device 110a and the messaging system server 105. For example, the user device 110a may perform cross-application or cross-device operations by putting messages to or getting messages from a corresponding message queue 145 via one or more user API calls to the messaging system server 105. In some instances, the user device 110a may be associated with a particular user group in an organization that uses the message queuing service 135. Which message queue of the at least one message queue 145 the user device 110a may be associated with may be determined by the user group, the applications run on the user device 110a, an identity of a user of the user device 110a, or the like.

A user device 110b may include one or more administrator APIs 160 that may facilitate communication between the user device 110b and both the messaging system server 105 and the client server 115. For example, the user device 110b may communicate with the messaging system server 105 using the administrator APIs 160 to monitor usage of the messaging system, configure the messaging system, troubleshoot the messaging system, determine metrics or parameters associated with the messaging system, or the like.

In some examples, the one or more user devices 110 may be in communication with one another via the at least one communication network 120. The one or more user devices 110 may be any type of computing device, such as a desktop computer, laptop, mobile phone, tablet, database, personal digital assistant (PDA), tablet, personal computer, a terminal device, a workstation, a mainframe computer, a supercomputer, a server, or other electronic device. The one or more user devices 110 may be enabled with Internet access and locatable by the at least one communication network 120. In one aspect, the one or more user devices 110 may be configured to transmit instructions to control various devices, receive data or other signals from external devices, and transmit the received data or other data to the at least one communication network 120, a server, or another user device 110 (e.g., a database) of the network environment 100.

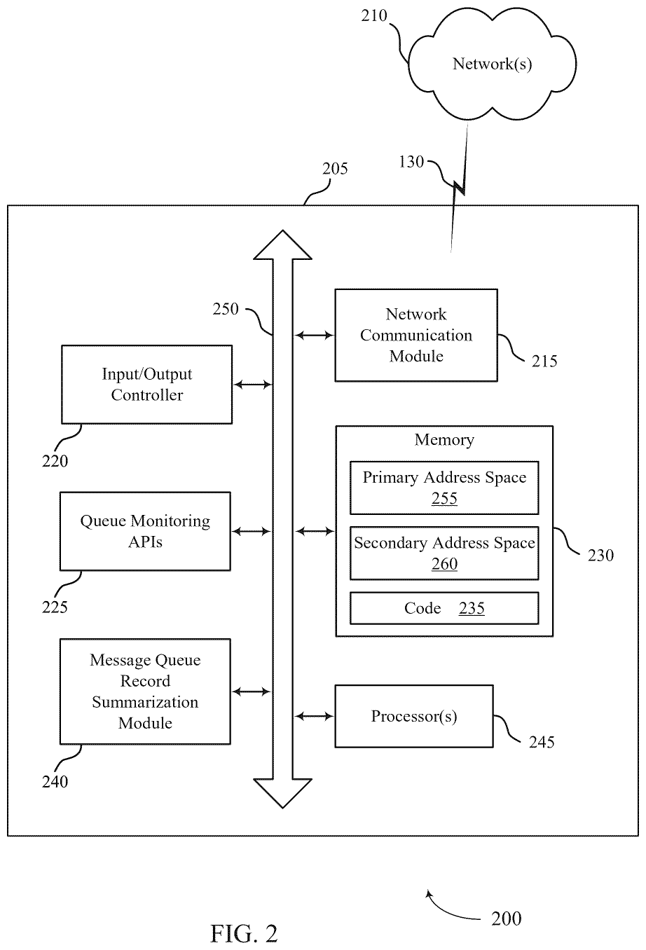

The client server 115, described in greater detail below with respect to FIG. 2, may include a message queue record summarization module 165 for summarizing one or more records generated by the messaging system server 105 (e.g., generated by the one or more queue managers 140, the at least one queue 145, the system performance and activity monitoring module 150, and/or another component of the messaging system server 105). For simplicity, the client server 115 is illustrated in FIG. 1 as a single server device. However, the client server 115 may be implemented in a distributed manner and connected via the communication network 120. In some instances, the client server 115 is co-located with the messaging system server 105, the user device 110a, and/or the user device 110b.

The at least one communication network 120 may include a local area network (LAN), a wide area network (WAN), and/or other types of networks, supporting protocols like transmission control protocol/Internet protocol (TCP/IP) over Ethernet. In other examples, the at least one communication network 120 may include an Automatic Data Processing (ADP) device coupled to a plurality of server devices that may host a plurality of databases and a plurality of client devices via the at least one communication network 120. The ADP device may store one or more applications that can include executable instructions that, when executed by the ADP device, cause the ADP device to perform desired actions, such as to transmit, receive, or otherwise process network messages, for example, and to perform other actions described and illustrated herein with reference to the figures. The applications may be implemented as modules or components of other applications. Further, the applications can be implemented as operating system extensions, modules, plugins, or the like.

The at least one communication network 120 may include a cloud network having resources to manage and deliver computing services over the Internet or other communication forms. Portions of the at least one communication network 120 may be executed within or as a virtual machine or a virtual server that may be managed in a cloud-based computing environment. Also, the one or more applications, and even the ADP device itself, may be located in one or more virtual servers running in a cloud-based computing environment rather than being tied to one or more specific physical network computing devices. For example, the one or more applications may be running in one or more virtual machines (VMs). In some examples, the at least one communication network 120 may include elements such as data centers, virtualized resources, cloud services, and security tools. In some aspects, the at least one communication network 120 may utilize data centers that also host servers capable of processing, storing, and managing network traffic, allowing centralized control without on-site hardware.

Additionally, in some examples, elements within the network environment 100 may include components such as processors, memory, displays, input devices, medium readers, network interfaces, and output devices. The processors may be configured to execute software instructions for performing functions like receiving queries, analyzing them, retrieving resolutions, and displaying results.

In other examples, the network environment 100 of FIG. 1 may include computational and storage capabilities such as processing power, memory, networking, and storage required for the computational success of a program. In some instances, the network environment 100 may integrate cloud computing where applications may access large amounts of computing power on demand, allowing them to scale resources up or down based on computational and storage needs.

In some examples, the network environment 100 of FIG. 1 may be implemented in an organization or enterprise system having multiple lines of business. Each line of business may include at least one user device 110a that performs queue operations using the messaging system server 105. Multiple lines of business may share the resources of the message queueing service 135. For example, multiple lines of business may be assigned to the same respective queue manager 140. However, in some examples, each line of business is assigned to one or more respective queues 145 that are not shared. Different lines of business (e.g., different user devices 110a) may perform different amounts of transactions, each requiring different amounts of processing resources from the message queuing service 135.

The network environment 100 may be implemented within an organization or institution that handles large amounts of operations or transactions. The organization or institution may handle data related to these operations or transactions by generating messages that are input to the client queue manager 140, which are then sorted into the message queue 145. Each transaction may therefore be associated with a respective message queue, and each queue may have a respective queue name. As described above, usage of respective message queue 145 may be organized according to lines of business or departments within an organization. The environment 100 may therefore employ a method of billing, or otherwise allocating resources to, respective lines of business based on queue names associated with respective transactions or messages. For example, the environment 100 may perform z/OS MQ billing by queue name.

For example, the network environment 100 may be implemented within a financial institution, such as a multinational financial services firm, which handles many transactions from customers around the world in a short timeframe. Processing each transaction may cause one or more messages to be added to at least one respective message queue 145. As a result, the message queuing service 135 may process very large numbers of messages in a short period of time. For each message processed, the message queuing service 135 may further generate large amounts of system performance and monitoring data (e.g., using the system performance and monitoring module 150) associated with the processing of these queue messages. In other examples, the network environment 100 may be implemented within other types of institutions, such as medical, government, product management and distribution, transportation services, or the like.

Messaging queuing systems may include components that collect system performance and activity monitoring data related to message processing, sometimes referred to as accounting data. As an example, an IBM Z Performance and Capacity Analytics (IZPCA) component may collect system performance data from, for example, IBM system management facilities (SMF), and store the data in a Db2 database. In an organization processing large volume of transactions in short timeframes, the volume of system performance and activity monitoring records conventionally written to a system performance and monitoring module may overwhelm the data collection components. For example, the volume of records written to the SMF in the short timeframe may overwhelm the SMF collection and the IZPCA components. As will be described in greater detail below, the message queue record summarization module 165 may therefore enable these collection components to support the volume of data generated by the message queuing server 135 without the need for excessive processing and memory resources.

FIG. 2 is a schematic block diagram of an example computer system 200 for summarizing data related to messages in a message queue. The computer system 200 may include a device 205 and a network 210. In some instances, the device 205 may be, or include aspects of, the client server 115 of FIG. 1. In some instances, the network 210 may be, or include aspects of, the at least one communication network 120 of FIG. 1.

The device 205 may include a network communication module 215, an input/output (I/O) controller 220, one or more queue monitoring APIs 225, a memory 230 having software code 235 stored therein, a message queue record summarization module 240, at least one processor 245, and at least one bus 250. The memory 230 may be configured with a bidirectional dual address space having a primary address space 255 and a secondary address space 260. A bidirectional dual address space may be, for example, a memory architecture where two distinct address spaces are used for data processing. Each address space in a bidirectional dual address space can be independently accessed and managed, which may improve memory usage and reduce conflicts. Data in a bidirectional dual address space can be accessed and processed in both forward and backward directions between the two address spaces. The bidirectional dual address space may be used to summarize system performance and activity monitoring records in-memory in a faster manner than is conventionally used to process records, such as type 116 records, described in greater detail below.

While described herein as using a bidirectional dual address space having a primary address space 255 and a secondary address space 260, in some examples, the memory 230 may be configured with more than two address spaces (e.g., as a multi-directional address space).

The network communication module 215 may facilitate wired or wireless communication between the device 205 and the network 210 and/or communication between the various components of the device 205 and the network 210. For example, using the network communication module 215 and the queue monitoring APIs 225, the device 205 may communicatively connect to the one or more queue managers 140 of the messaging system server 105 illustrated in FIG. 1.

Using the queue monitoring APIs 225, the device 205 may communicatively connect to a message queuing service, such as the message queuing service 135 of FIG. 1, to receive data related to operation of queue managers 140, individual queues 145, and/or other components of the messaging system server 105 illustrated in FIG. 1. Data received using the queue monitoring APIs 225 may include, for example, an indication or status of active queue managers, an indication or status of queues managed by the active queue managers, status information of channels connecting the queues to respective queue managers, system performance and activity monitoring records associated with the message queuing service, or a combination thereof. In some instances, the data received using the queue monitoring APIs 225 may include address information associated with the queue managers, address information associated with the queues, address information associated with a system performance and activity monitoring module (e.g., the system performance and activity monitoring module 150 of FIG. 1), or a combination thereof. In some instances, the data received via the queue monitoring APIs 225 does not include the queue messages themselves, but rather data associated with queue messages.

The message queue record summarization module 240, otherwise referred to herein as the record summarization module 240, may process the data, or records, received via the queue monitoring APIs 225. The record summarization module 240 may generate and store (e.g., in the memory 230) at least one record summary, such that an amount of data stored for the at least one record summary is less than a total amount of data received. The record summarization module 240 may receive tens of thousands records per second that are generated by the message queuing service, and the record summarization module 240 may summarize these records to a higher granularity that is usable by, for example, a system administrator. By way of example, an IBM MQ messaging service may generate forty thousand type 116 records per second that are related to queue messages. Type 116 records may be used to collect detailed accounting data related to an IBM MQ messaging service. These records provide information about various aspects of the messaging service operations, including message flow, queue usage, and resource consumption. While type 116 records are described herein by way of example, other message queuing services may generate similar accounting records. Manually extracting relevant information may be an extremely time-consuming and error-prone process, as these records are continuously updated and generated. Furthermore, because of the large number of records generated per second, the amount of memory that would be required to store these records as is, in order to analyze or reference them at a later time, may be unattainable.

The record summarization module 240 may extract, from the records, key information for populating a record summary data structure. For example, the record summarization module 240 may extract, from respective records related to queue messages, information including at least one operation identifier (ID) to which a related queue message corresponds (e.g., a queue transaction identifier), a queue ID (e.g., an identifier of the queue in which a related message is held), a queue manager ID (e.g., an identifier of the queue manager for the queue holding the related message), a virtual storage identifier (e.g., identifying an instance of virtual storage in the messaging system server 105 of FIG. 1 to which a respective queue manager is associated), a record source ID (e.g., identifying a source of system performance and activity monitoring records in the messaging system server 105), a connection type for the related message (e.g., a batch connection type or a real-time connection type), or a combination thereof. By way of example, a virtual storage ID may include a multiple virtual storage (MVS) ID and a record source ID may include a system management facilities (SMF) ID.

In some examples, the record summary data structure may be a non-linear high indexing data structure, such as a B-tree or other structure. The record summarization module 240 may populate the record summary data structure such that each record summary summarizes records received over a predetermined time interval. For example, respective record summaries may summarize data at thirty-minute intervals, at hourly intervals, at two-hour intervals, at daily intervals, or another suitable interval. In some examples, the time intervals may be set by a user or an administrator. In other examples, the time intervals may be dynamically updated based on a current status of any of the components of the messaging service. For example, if the queue managers are at a threshold capacity of messages in one or more of their respective message queues, the record summarization module 240 may decrease the time interval in order to more quickly process the high load of messages.

For each predetermined time interval, the record summary may further indicate a proportion of operations performed using respective queues, a total number of operations performed by each queue, a proportion of messages processed using respective queues, a total number of messages processed by each queue, or a combination thereof. In some instances, for each predetermined time interval, the record summary may indicate a maximum computer processing unit (CPU) utilization of one or more message queues, a minimum CPU utilization of one or more message queues, an average CPU utilization of one or more message queues, or a combination thereof.

As described above, each queue transaction or operation processed using the message queuing service 135 may cause at least one queue message to be generated using the messaging system server 105. The record summary may therefore provide the ability to measure, summarize, and compare the processing activity related to a message queuing service at the queue manager level, the queue level, and transaction level over a time interval (e.g., an hourly time interval). For example, the record summary may include measurements of CPU time associated with message volumes and/or transaction volumes by application area. In some examples, each application area may correspond to, for example, at least one respective user device (e.g., at least one user device 110a), at least one respective line of business, or both.

In this manner, the record summary may allow for clear and efficient comparison of the usage of each queue in the messaging system. For example, user groups in a messaging system may each be assigned to one or more respective queues. Accurate identification and summarization of queue usage for each user group may enable system administrators to appropriately configure the message queuing service to accommodate the processing and resource needs of each user group.

In some instances, each record summary may include a queue summary that summarizes data related to respective queues active in the messaging system and an operation summary that summarizes data related to respective operations performed by the message queuing service. As an example, index keys for the queue summary may include a record source ID, a queue manager ID, and a queue ID. As another example, index keys for the operation summary may include a record source ID, a queue manager ID, a connection type, and an operation ID. However, other key information may be used for the queue summary and/or the operation summary.

The record summaries therefore facilitate allocation of the supporting resources and costs for the message queuing service to its users. Further, the record summary may enable, for example, an SMF collection component and IZPCA collector to support the volume of data generated with the message queuing service, without requiring exorbitant amounts of CPU and storage to process the generated data.

Memory 230 may be provided in the form of a single memory unit or multiple memory units and may be one or more articles of manufacture and/or machine components. Memory 230 may include static memory, dynamic memory, or both in communication. In some examples, memory 230 may be one or more tangible storage mediums that can store data and executable instructions and may be non-transitory during the time instructions are stored therein. Memory 230 may be volatile or non-volatile, secure and/or encrypted, unsecure and/or unencrypted.

The software code 235 stored in memory 230 may include the software code needed for the record summarization module 240 to operate. In some examples, portions of the software code 235 may reside in the primary address space 255, the secondary address space 260, or both. For example, a first portion of the software code 235 used to perform a first set of functions of the record summarization module 240 may reside in the primary address space 255, and a second portion of the software code 235 used to perform a second set of functions of the record summarization module 240 may reside in the secondary address space 260.

The at least one processor 245, in some instances, may be a general-purpose processor or may be part of an application-specific integrated circuit (ASIC). In other instances, the at least one processor 245 may be a microprocessor, a microcomputer, a processor chip, a controller, a microcontroller, a digital signal processor (DSP), a state machine, or a programmable logic device (PLD). Additionally, any processor described herein may be provided in the form of a single processor, multiple processors, and/or parallel processors. Multiple processors may be included in or coupled to, a single device or multiple devices.

The I/O controller 220 may manage input and output signals for the device 205. The I/O controller 220 may also manage peripherals not integrated into the device 205. In some cases, the I/O controller 220 may represent a physical connection or port to an external peripheral. In some cases, the I/O controller 265 may utilize an operating system such as iOS®, ANDROID®, z/OS®, MS-DOS®, MS-WINDOWS®, OS/2®, UNIX®, LINUX®, or another known operating system. Additionally, or alternatively, the I/O controller 220 may represent or interact with a modem, a keyboard, a mouse, a joystick, a trackball, a microphone, a touchpad, a touchscreen, a display, a screen, a monitor, a speaker, or similar devices. In some cases, the I/O controller 220 may be implemented as part of one or more processors, such as the at least one processor 245. In some cases, a user may interact with the device 205 via the I/O controller 220 or via hardware components controlled by the I/O controller 220.

The components of the device 205 may be interconnected and communicate via the at least one bus 250 or other communication link. The at least one bus 250 may enable communication via any standard or specification such as peripheral component interconnect, peripheral component interconnect express, parallel advanced technology attachment, or serial advanced technology attachment. The at least one bus 250 may be provided in the form of a single bus or multiple buses that are operatively interconnected.

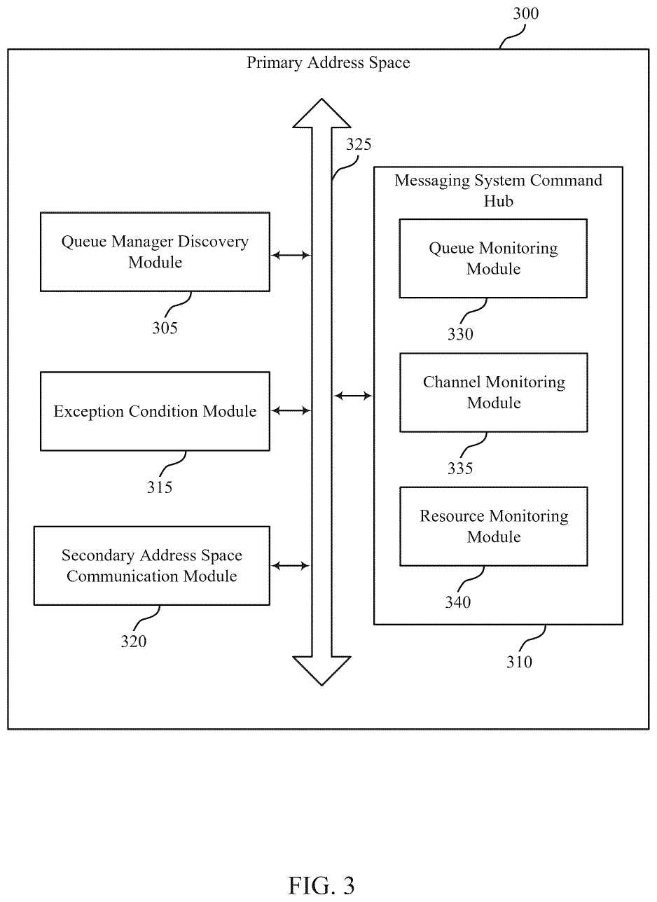

FIG. 3 is a diagram of an example primary address space 300 of a bidirectional dual address space. In some aspects, the primary address space 300 may be, or include aspects of, the primary address space 255 of FIG. 2. The primary address space 300 may include a queue manager discovery module 305, a messaging system command hub 310, an exception condition module 315, and a secondary address space communication module 320. The queue manager discovery module 305, messaging system command hub 310, the exception condition module 315, and the secondary address space communication module 320 may be communicatively and/or operatively connected to one another via at least one central interface bus 325.

The queue manager discovery module 305 may discover and facilitate connection to active queue managers of a message queueing service, such as the queue managers 140 of the message queuing service 135 of FIG. 1. For example, the queue manager discovery module 305 may receive, from a messaging system server (e.g., the messaging system server 105 of FIG. 1), a lookup table indicating active queue managers in the messaging system. The lookup table may be, for example, a subsystem vector table, a subsystem communications vector table, or other data structure indicative of active queue managers in the messaging system server. For example, the queue manager discovery module 305 may scan the lookup table to locate and automatically connect to active messaging system subsystems corresponding to active queue managers. In some examples, the queue manager discovery module 305 detects active queue managers by scanning early subsystem initialization (ERLY) blocks associated with a subsystem communications vector table. In other examples, the queue manager discovery module 305 may locate and connect to the active queue managers via other means, such as by request to the messaging system.

In some examples, the queue manager discovery module 305 may include aspects of a main subroutine of the primary address space 300, such as an IBM $MQMAIN task control block. As an example, a system level function or routine, such as IBM IEAVAR00, may set up an initial environment for message queue operations. A job step task control block, such as IEESB605 may be executed within IBM IEAVAR00 to manage the state and execution of the job step within IBM MQ. IEESB605 may call a main task control block, such as $MQMAIN, to communicate with the z/OS operating system, to communicate with one or more queue managers, to call child subtasks (e.g., child task control blocks), or combinations thereof. The components of the primary address space 300 may implement dynamic subtask communication and serialization. For example, the functions and components implemented by the primary address space 300 may provide a dynamic handshake protocol to each other, and between other main subtasks. Each subtask may be protected by a respective z/OS recovery mechanism, such as an extended area save (ESTAE), a functional recovery routine (FRR), an associated recovery routine (ARR), and/or another recovery mechanism.

In some examples, the queue manager discovery module 305 may communicate with additional components of the operating system and/or the messaging system of the messaging system server. In some examples, operations performed by the queue manager discovery module 305 may be part of a main subtask of the primary address space 300. In some examples, the queue manager discovery module 305 may receive address information associated with a source of system performance and activity monitoring records for the messaging system (e.g., the system performance and activity monitoring module 150 of FIG. 1).

The messaging system command hub 310 may include a queue monitoring module 330, a channel monitoring module 335, and a resource monitoring module 340. The messaging system command hub 310 may make function and/or API calls to the messaging system server (e.g., to respective queue managers to which the primary address space 300 is connected) for monitoring and/or configuration operation of the message queuing server. In some examples, operations performed by the messaging system command hub 310 are part of a child subtask of the primary address space 300.

The queue monitoring module 330 may collect information related to respective queues managed by one or more active queue managers to which the primary address space 300 is connected. For example, the queue monitoring module 330 may collect the address, queue ID (e.g., queue name), utilization, capacity, and/or other information of respective queues. In some examples, the queue monitoring module 330 may store some of the collected information. For example, the queue monitoring module 330 may detect an increasing pattern of queue depth messages and/or an abnormal number of messages relative to the day of week, time of day, or the like. In some examples, the queue monitoring module 330 may include aspects of an IBM $MQ2SYSQ task control block. In some examples, a gate subtask, such as $MQ2GATE, may be a child subtask attached to the $MQMAIN subroutine of the primary address space 300 and may operate as a bridge between $MQMAIN and $MQ2SYSQ.

The channel monitoring module 335 may collect information related to channels, or communication links, between respective queue managers, between queues and queue managers, between a client device (e.g., the user device 110a of FIG. 1) and respective queue managers, or a combination thereof. For example, the channel monitoring module 335 may receive, from the messaging system server, a channel mapping that indicates statuses of respective channels in the messaging system. For example, the channel monitoring module 335 may detect an increasing pattern of messages and/or an abnormal number of messages relative to the day of week, time of day, or the like. In some examples, the channel monitoring module 335 may include aspects of an IBM $MQ2SYSC task control block. In some examples, a gate subtask, such as $MQ2GATE, may be a child subtask attached to the $MQMAIN subroutine of the primary address space 300 and may operate as a bridge between $MQMAIN and $MQ2SYSC.

The resource monitoring module 340 may collect information related to queue manager resources, queue resources, messaging system resources, operating system resources of the messaging system server 105, or a combination thereof. For example, the resource monitoring module 340 may collect storage information, active user information, and/or other resource information. In some examples, the resource monitoring module 340 includes aspects of an IBM $MQ2SYSR task control block. In some examples, a gate subtask, such as $MQ2GATE, may be a child subtask attached to the $MQMAIN subroutine of the primary address space 300 and may operate as a bridge between $MQMAIN and $MQ2SYSR.

The exception condition module 315 may detect exception conditions associated with messaging system. The exception condition module 315 may scan information received by the queue monitoring module 330, the channel monitoring module 335, and/or the resource monitoring module 340 to detect exception conditions related to one or more queues, one or more queue managers, one or more channels, or other components of the messaging system. In some examples, the exception condition module 315 may detect a non-operational channel, for example, by scanning the channel mapping area. In some examples, the exception condition module 315 may detect that one or more queues have exceeded a utilization threshold for at least a minimum period of time (e.g., a 100% utilization, 90% utilization, 80% utilization, etc.). The minimum period of time may be, for example, thirty seconds, sixty seconds, two minutes, or another amount of time. In some examples, the minimum period of time may be dependent on the utilization threshold being exceeded. The exception condition module 315 may generate one or more notifications or alerts related to detected exception conditions. In some examples, the exception condition module 315 may cause the primary address space 300 to output the notification or alert to a user device (e.g., the user device 110b of FIG. 1).

The secondary address space communication module 320 may facilitate cross-memory communication between the primary address space 300 and a secondary address space (e.g., the secondary address space 260 of FIG. 2). For example, the secondary address space communication module 320 may route location information of a source of system performance and activity monitoring records to the secondary address space. The secondary address space communication module 320 may also receive information from the secondary address space.

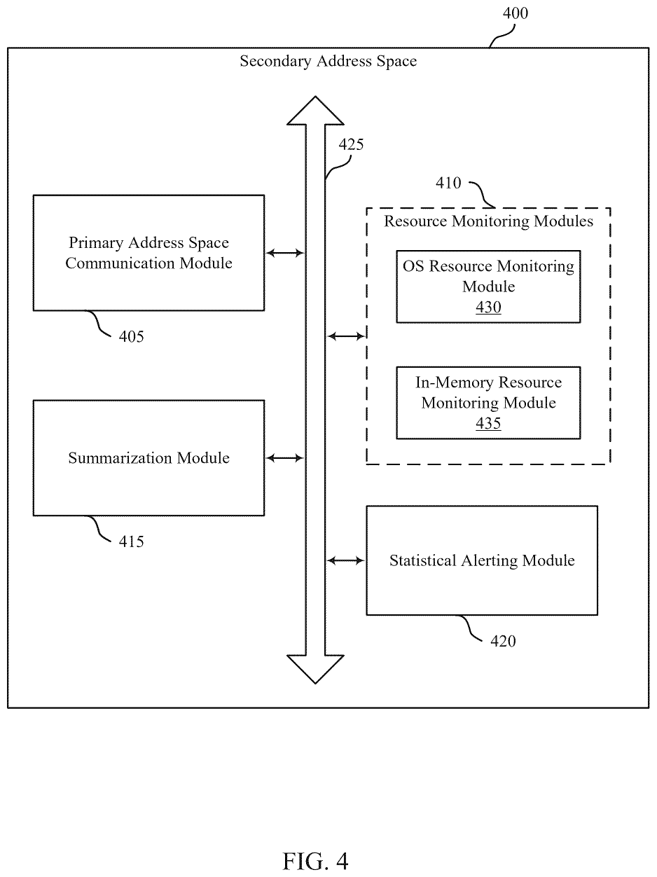

FIG. 4 is a diagram of a secondary address space 400 of a bidirectional dual address space. In some aspects, the secondary address space 400 may be, or include aspects of, the secondary address space 260 of FIG. 2. The secondary address space 400 may include a primary address space communication module 405, one or more resource monitoring modules 410, a message queue summarization module 415, and a statistical alerting module 420. The primary address space communication module 405, the one or more resource monitoring modules 410, the summarization module 415, and the statistical alerting module 420 may be communicatively and/or operatively connected to one another via at least one central interface bus 425.

In some examples, the primary address space communication module 405 and/or the summarization module 415 include aspects of a main subroutine of the secondary address space 400, such as an IBM #MQMAIN task control block. The main subroutine of the secondary address space 400 may interact with major z/OS operating system components of the message queueing service and may communicate with the main subroutine of the primary address space 300. The components of the secondary address space 400 may implement dynamic subtask communication and serialization. For example, the functions and components implemented by the secondary address space 400 may provide a dynamic handshake protocol to each other, and between other main subtasks. Each subtask may be protected by a respective z/OS recovery mechanism, such as ESTAE, FRR, ARR, and/or another recovery mechanism.

The one or more resource monitoring modules 410 may each include an operating system resource monitoring module 430 that may facilitate collection of one or more operating system resources of the messaging system server 105 using, for example, a cross-memory function call. In some examples, the operating system resource monitoring module 430 may include aspects of an IBM #MQ2ZOS task control block. In some examples, a gate subtask, such as #MQ2GATE, may be a child subtask attached to the #MQMAIN subroutine of the secondary address space 400 and may operate as a bridge between #MQMAIN and #MQ2ZOS. For example, #MQ2ZOSR may operate with major z/OS components via a cross-memory call.

The resource monitoring modules 410 may include an in-memory resource monitoring module 435 that may facilitate collection of records related to messages held in message queues of the messaging system. For example, the in-memory resource monitoring module 435 may communicatively connect the secondary address space 400 to an in-memory resource of system performance and activity monitoring records (e.g., the system performance and activity monitoring module 150 of FIG. 1). In some examples, the in-memory resource monitoring module 435 includes aspects of an IBM #MQ2SYSR task control block. In some examples, a gate subtask, such as #MQ2GATE, may be a child subtask attached to the $MQMAIN subroutine of the secondary address space 400 and may operate as a bridge between #MQMAIN and #MQ2SYSR. In some examples, #MQ2SYSR may interact with SMF in-memory (INMEM) base control program (BCP) components.

In some examples, the in-memory resource monitoring module 435 may collect the system performance and activity monitoring records using a blocking GET call to the in-memory resource. A blocking GET call may be a method of retrieving messages where the call waits (e.g., blocks) until a message is available in the queue. Blocking GET calls may pause execution of the program in the respective address space until the message is retrieved. Blocking GET calls may ensure that a message is processed before proceeding with further operations.

The system performance and activity monitoring records may include performance metrics such as a total number of messages processed with a queue or queue manager, CPU utilization, and/or other performance statistics of a queue or queue manager. As an example, the system performance and activity monitoring records may include type 115 records, though other record types are contemplated. Type 115 records may be used to collect performance statistics related to an IBM MQ messaging service. These records provide periodic snapshots of the messaging service performance metrics, such as the number of messages processed, CPU usage, and other performance-related data. While type 115 records are described herein by way of example, other message queuing services may generate similar performance records.

The system performance and activity monitoring records may include accounting information such as numbers and types of API calls to the messaging system (e.g., a number of PUT/POST calls, a number of GET calls, etc.), task-level data for each queue in the messaging system, and/or other accounting data. PUT calls may be used to update or replace the content of a message in a specific location of a queue. POST calls may be used to add a new message to a queue. As an example, the system performance and activity monitoring records may include type 116 records, though other record types are contemplated. As an example, IBM MQ accounting data may be available in an SMF 116 MQ accounting record.

The summarization module 415 may generate record summaries of data received by the resource monitoring modules 410. In some instances, the summarization module 415 may be, or include aspects of, the message queue record summarization module 165 or the message queue record summarization module 240 of FIGS. 1 and 2, respectively. In some examples, some or all of the summarization module 415 may be included in the primary address space 300. In some examples, the summarization module 415 may output generated record summaries to be stored at the source of the system performance and activity monitoring records (e.g., the system performance and activity monitoring module 150 of FIG. 1). In some examples, the summarization module 415 may output generated record summaries to a user device (e.g., the user device 110b of FIG. 1). In some examples, the summarization module 415 may store the record summary locally (e.g., in the memory 230 of the device 205).

As described above, the bidirectional dual address space may be used to summarize system performance and activity monitoring records in-memory in a faster manner than is conventionally used to process, for example, traditional type 116 records. In some examples, the summarization module 415 may write the record summaries to, for example, the SMF as a user-defined record. The process of generating record summaries may dramatically reduce the volume of records held in, for example, the SMF. Further, these record summaries may be easily loaded into database objects (e.g., IBM Db2 objects) for further processing.

The statistical alerting module 420 may process statistical records or other information received by the resource monitoring modules 410 and generate one or more alerts related to performance of the messaging system. In some examples, the statistical records may be included as part of the system performance and activity monitoring records. The statistical alerting module 420 may detect any abnormalities in the performance of the messaging system based on the statistical records and generate near real-time alerts based on detected abnormalities. In some instances, the statistical records may include data related to when CPU utilization by a queue or other component exceeds a threshold. In some examples, the statistical alerting module 420 may transmit the alerts to a user device (e.g., the user device 110b of FIG. 1). In some examples, the statistical alerting module 420 may transmit the alert to the primary address space 300.

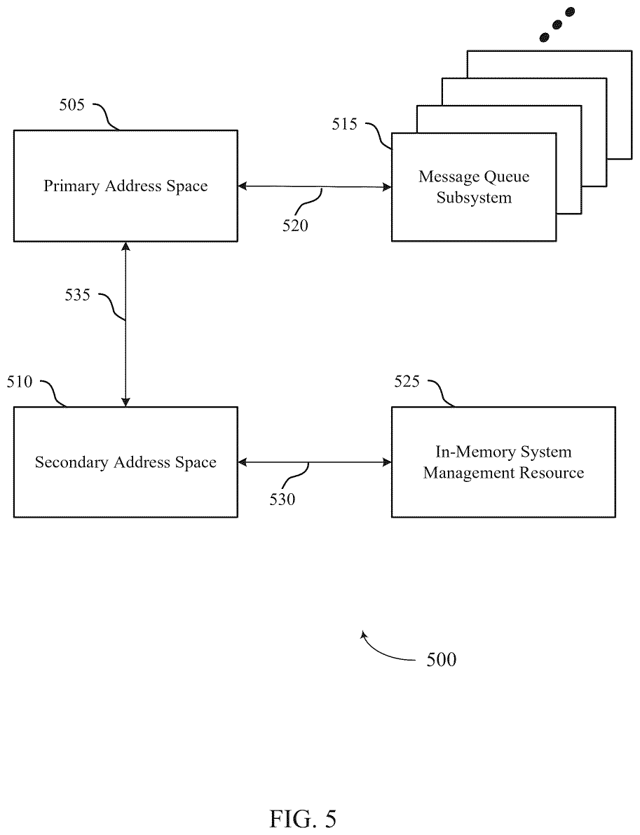

FIG. 5 is workflow diagram for an example system 500 having a bidirectional dual address space. The system 500 may include a primary address space 505 and a secondary address space 510, which together form a bidirectional dual address space. In some instances, the primary address space 505 may be, or include aspects of, the primary address space 255 or the primary address space 300 of FIGS. 2 and 3, respectively. In some aspects, the secondary address space 510 may be, or include aspects of, the secondary address space 260 or the secondary address space 400 of FIGS. 2 and 4, respectively.

The primary address space 505 may communicatively connect to one or more message queue subsystems 515 to receive information related to operation of each message queue subsystem 515. The primary address space 505 may communicate with the one or more message queue subsystems 515 using various API calls to request information from the one or more message queue subsystems 515. For example, a signal 520 between the primary address space 505 and the one or more message queue subsystems 515 may include requests for information, queue manager IDs, queue IDs, channel mappings, and/or other messaging system resource information. In some examples, the one or more message queue subsystems 515 may be, or include aspects of, the one or more queue managers 140 of FIG. 1.

The secondary address space 510 may communicatively connect to an in-memory system management resource 525 to receive data related to messages processed by the one or more message queue subsystems 515. The secondary address space 510 may communicate with the in-memory system management resource using various API calls to request records related to messages processed by the one or more message queue subsystems 515. For example, at least one signal 530 between the secondary address space 510 and the in-memory system management resource 525 may include requests for information (e.g., GET calls), system performance and activity monitoring records, and/or other system management resource information of the messaging system. The system performance and activity monitoring records may include accounting records, performance statistics, and other data related to operation of the messaging system. In some examples, the in-memory system management resource may be, or include aspects of, the system performance and activity monitoring module 150 of FIG. 1.

In some examples, the secondary address space 510 may communicatively connect to the in-memory system management resource 525 based at least in part on information received from the primary address space 505. For example, at least one signal 535 between the primary address space 505 and the secondary address space 510 may include a reference to (e.g., an address of) the in-memory system management resource 525. In some examples, the signal 535 between the primary address space 505 and the secondary address space may further include information received by the primary address space from the one or more message queue subsystems (e.g., via the signal 520). For example, the signal 535 may include one or more queue manager IDs, queue IDs, and/or other information related to the one or more message queue subsystems 515.

The secondary address space 510 may generate at least one record summary based on information received from the in-memory system management resource 525 (e.g., received via the signal 530). The secondary address space 510 may generate a respective record summary summarizing the received information every hour, every two hours, or at another predetermined time interval. In some examples, the secondary address space may output the at least one record summary for storage in the in-memory system management resource 525 at the predetermined time interval. In such examples, the signal 530 may include the at least one record summary. In some examples, the secondary address space may output the at least one record summary to the primary address space 505. In such examples, the signal 535 may include the at least one record summary.

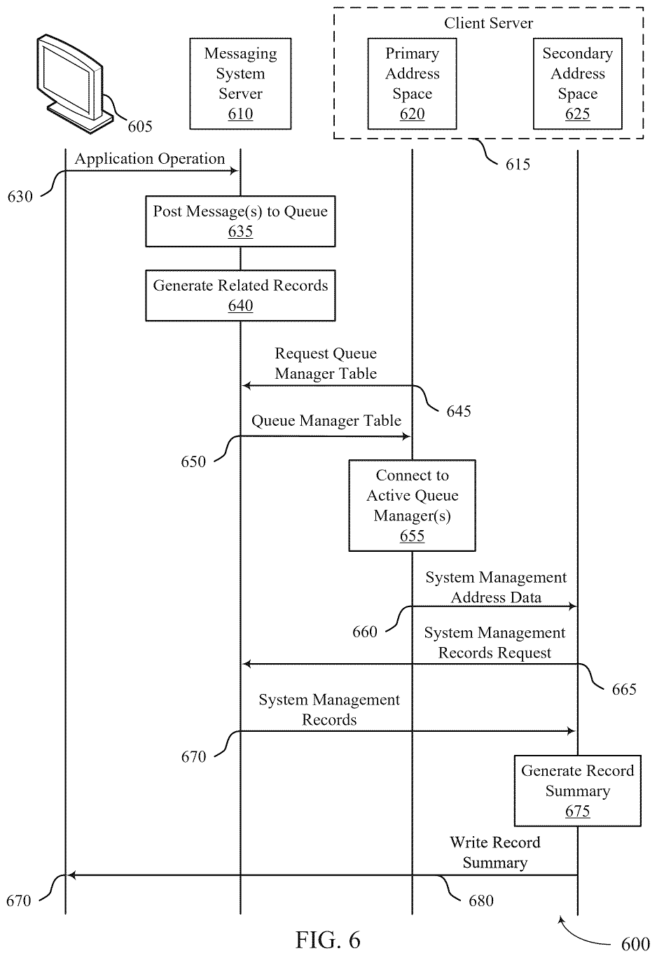

Turning to FIG. 6, a swimlane diagram of a system 600 for generating a record summary of data related to messages in at least one message queue is shown, according to an example. The system 600 may include one or more user devices 605, a messaging system server 610, and a client server 615. The one or more user devices 605 may be, or include aspects of, the one or more user devices 110 of FIG. 1. The messaging system server 610 may be, or include aspects of, the messaging system server 105 of FIG. 1. The client server 615 may be, or include aspects of, the client server 115 or the device 205 of FIGS. 1 and 2, respectively. The client server 615 may include a primary address space 620 and a secondary address space 625. The primary address space 620 may be, or include aspects of, the primary address space 255, the primary address space 300, or the primary address space 505 of FIGS. 2, 3, and 5, respectively. The secondary address space 625 may be, or include aspects of, the secondary address space 260, the secondary address space 400, or the secondary address space 510 of FIGS. 2, 4, and 5, respectively.

An application operation 630 (e.g., a cross-application operation) may be transmitted by the one or more user devices 605 in the form of, for example, one or more commands to a message queue included in the messaging system server 610. The messaging system server 610 may receive the application operation 630, and post one or more messages 635 associated with the application operation 630 to a selected queue. In some examples, the messaging system server 610 may select the queue based on a type of the application operation 630, credentials of the one or more user device 605, queue utilization, or other criteria. The messaging system server 610 may generate related records 640 with respect to the message 635. The related records 640 may include data related to processing of the message 635, the application operation 630, the selected queue, a manager of the selected queue, or other performance metrics of the messaging system server 610.

The primary address space 620 of the client server 615 may transmit or otherwise output, to the messaging system server 610, a request 645 for a table or other data structure indicative of active queue managers (e.g., active subsystems) in the messaging system server 610. The primary address space 620 may receive, from the messaging system server 610, a lookup table 650 or other data structure indicative of active queue managers in the messaging system server 610. As an example, the lookup table 650 may include a subsystem vector table. The lookup table 650 may include additional information (e.g., addresses, statuses, identifiers, etc.) related to the components of the messaging system server 610.

The primary address space 620 may scan the received lookup table 650 and communicatively connect to one or more queue managers 655 indicated in the lookup table 650. The one or more queue managers 655 to which the primary address space 620 connects may include each active queue manager in the messaging system server 610. For example, the one or more queue managers 655 may include the queue manager that manages the selected queue to which the message 635 is posted.

The primary address space 620 may transmit or otherwise output, to the secondary address space 625, system management address data 660 of the messaging system server 610. In some examples, the primary address space 620 may extract the system management address data 660 from the lookup table 650. In other examples, the primary address space 620 may receive the system management address data 660 via additional communication with the messaging system server 610. The system management address data 660 may include a storage location of the related records 640 generated by the messaging system server 610.

The secondary address space 625 may receive the system management address data 660 and transmit or otherwise output a request 665 for system management records to the messaging system server 610 using the system management address data 660. In some examples, the secondary address space 625 may transmit the request 665 using a blocking GET service. The secondary address space 625 may receive, from the messaging system server 610, system management records 670. The system management records 670 may include data associated with a plurality of messages in at least one message queue in the messaging system server 610. For example, the system management records may include some or all of the related records 640. The system management records 670 may include additional related records generated with respect to other messages processed by the messaging system server 610. The system management records 670 may include accounting data and performance metrics of the messaging system server 610. In some examples, the system management records 670 may be, or include aspects of, the system performance and activity monitoring records described with respect to FIG. 1, 2, 4, or 5. In some examples, the secondary address space 625 may receive the system management records 670 in near real-time as they are generated by the messaging system server 610. In some examples, the secondary address space 625 may receive the system management records 670 in one or more batches.

The secondary address space 625 may generate, based on the system management records 670, at least one record summary 675 for each of at least a subset of a plurality of messages in the messaging system server 610. The secondary address space 625 may generate the at least one record summary in predetermined time intervals (e.g., at one-hour intervals) such that the at least one record summary 675 may summarize the system management records 670 received or generated during respective predetermined time intervals.

The secondary address space 625 may generate the at least one record summary 675 by extracting, from the system management records 670, operation IDs associated with message queue operations, queue IDs of respective queues in the messaging system, queue manager IDs of the one or more queue managers 655, record source IDs, virtual storage location IDs, connection types, or combinations thereof. For example, the at least one record summary may be in the form of a high indexing structure (e.g., a non-linear high indexing structure) having one or more key-value pairs based on operation ID, queue ID, queue manager ID, virtual storage location ID, record source ID, connection type, or a combination thereof.

In some examples, the at least one record summary 675 may include a first record summary having a first set of keys and a second record summary having a second set of keys different from the first set of keys. For example, the first record summary may be a queue summary including keys for virtual storage ID, record source ID, queue manager ID, queue ID, or a combination thereof. The second record summary may be an operations summary including keys for virtual storage ID, record source ID, queue manager ID, connection type, operation ID, or a combination thereof.

The secondary address space 625 may generate the at least one record summary 675 by extracting, from the system management records 670, CPU utilization for respective queues in the messaging system server 610, numbers of operations performed using respective queues in the messaging system server 610, numbers of messages held or processed by respective queues in the messaging system server 610, and/or other performance metrics of the messaging system server 610.

The at least one record summary 675 may indicate proportions or numbers of operations performed using respective queues in the messaging system server 610. The at least one record summary 675 may indicate CPU utilization (e.g., a maximum CPU utilization, a minimum CPU utilization, an average CPU utilization, an instantaneous CPU utilization) by respective queues in the messaging system server 610 over the predetermined time interval. The at least one record summary 675 may indicate payloads of one or more operations performed using the messaging system. The at least one record summary 675 may indicate resource types associated with the messages processed by the messaging system server 610.

The secondary address space 625 may perform a write operation 680 of the at least one record summary 675 to, for example, a memory location of the one or more user devices 605 (e.g., an administrator device or a client device). However, the secondary address space 625 may perform the write operation 680 of the at least one record summary with respect to other devices or components of the system 600, in lieu of or in addition to the one or more user devices 605. For example, the secondary address space 625 may perform the write operation 680 of the at least one record summary 675 with respect to a memory location within the messaging system server 610, within the client server 615, or both. In some examples, the secondary address space 625 may store the at least one record summary 675.

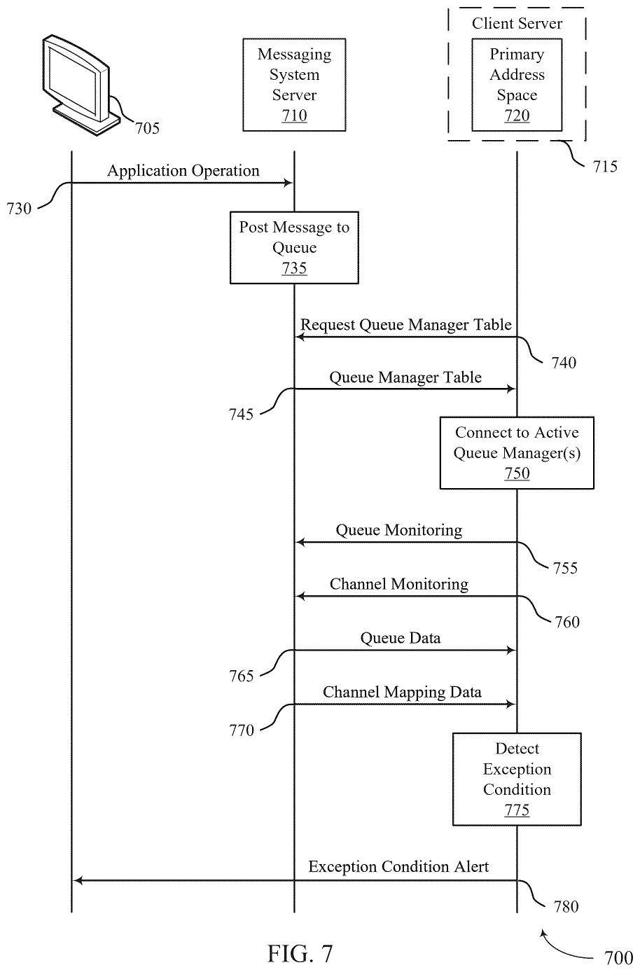

Turning to FIG. 7, a swimlane diagram of a system for detecting an exception condition associated with a messaging system is shown, according to an example. The system 700 may include one or more user devices 705, a messaging system server 710, and a client server 715. The one or more user devices 705 may be, or include aspects of, the one or more user devices 110 or the one or more user devices 605 of FIGS. 1 and 6, respectively. The messaging system server 710 may be, or include aspects of, the messaging system server 105 or the messaging system server 610 of FIGS. 1 and 6, respectively. The client server 715 may be, or include aspects of, the client server 115, the device 205, or the client server 615 of FIGS. 1, 2, and 6, respectively. The client server 715 may include a primary address space 720. The primary address space 720 may be, or include aspects of, the primary address space 255, the primary address space 300, the primary address space 505, or the primary address space 720 of FIGS. 2, 3, 5, and 6 respectively.

An application operation 730 (e.g., a cross-application operation) may be transmitted by the one or more user devices 705 in the form of, for example, one or more commands to a message queue included in the messaging system server 710. The messaging system server 710 may receive the application operation 730, and post one or more messages 735 for performing the application operation 730 to a selected queue. In some examples, the messaging system server 710 may select the queue based on a type of the application operation 730, credentials of the one or more user device 705, queue utilization, or other criteria.

The primary address space 720 of the client server 715 may transmit or otherwise output, to the messaging system server 710, a request 740 for a table or other data structure indicative of active queue managers (e.g., active subsystems) in the messaging system server 710. The primary address space 720 may receive, from the messaging system server 710, a lookup table 745 or other data structure indicative of active queue managers in the messaging system server 710. As an example, the lookup table 745 may include a subsystem vector table. The lookup table 745 may include additional information (e.g., addresses, statuses, identifiers, etc.) related to the components of the messaging system server 710.

The primary address space 720 may scan the received lookup table 745 and communicatively connect to one or more queue managers 750 indicated in the lookup table 745. The one or more queue managers 750 to which the primary address space 720 connects may include each active queue manager in the messaging system server 710. For example, the one or more queue managers 750 may include the queue manager that manages the selected queue to which the message 735 is posted.

The primary address space 720 may perform queue monitoring 755 of at least one queue managed by the one or more queue managers 750. The primary address space 720 may perform the queue monitoring 755 via one or more API calls to the messaging system server 710 requesting information (e.g., attributes and other resources) related to operation of the at least one queue.

The primary address space may perform channel monitoring 760 of one or more channels operating as communication links in the messaging system server 710. For example, the primary address space 720 may perform the channel monitoring 760 with respect to channels linking the one or more queue managers 750 to one another, channels linking queues to respective ones of the one or more queue managers 750, channels linking the one or more user devices 705 to the messaging system server 710, channels linking the client server 715 to the messaging system server 710, or combinations thereof.

Based on the queue monitoring 755, the primary address space 720 may receive queue data 765 from the messaging system server 710. The queue data 765 may include attributes or other resources related to at least one queue managed by the one or more queue managers 750 in the messaging system server 710. For example, the queue data 765 may include queue IDs (e.g., queue names), queue depths, queue utilization, or the like. In some examples, the primary address space 720 may receive or request the queue data 765 at predetermined time intervals (e.g., at 60 second intervals, at two-minute intervals, at hourly intervals, etc.).

Based on the channel monitoring 760, the primary address space 720 may receive channel mapping data 770 from the messaging system server 710. The channel mapping data 770 may indicate configurations, statuses, and other information related to the channels in the messaging system server 710. In some examples, the primary address space 720 may receive or request the channel mapping data 770 at predetermined time intervals (e.g., at 60 second intervals, at two-minute intervals, at hourly intervals, etc.)

The primary address space 720 may detect an exception condition 775 associated with the queue data 765 or the channel mapping data 770. The exception condition may be based on one or more parameters related to the one or more queue managers 750. For example, the exception condition 775 may indicate that a utilization of a queue is greater than a threshold utilization for at least a threshold time period. For example, the exception condition 775 may indicate that a utilization of a queue is at least 80% of the queue capacity for over 60 seconds. The exception condition 775 may indicate that at least one channel identified in the channel mapping data 770 is non-operational or otherwise experiencing an abnormality.

The primary address space 720 may output an exception condition alert 780 to, for example, the one or more user devices 705 (e.g., an administrator device or a client device). However, the primary address space 720 may transmit or otherwise output the exception condition alert 780 to other devices or components of the system 700, in lieu of or in addition to the one or more user devices 705. For example, the primary address space 720 may send the exception condition alert 780 to the messaging system server 710, another component of the client server 715, or both.

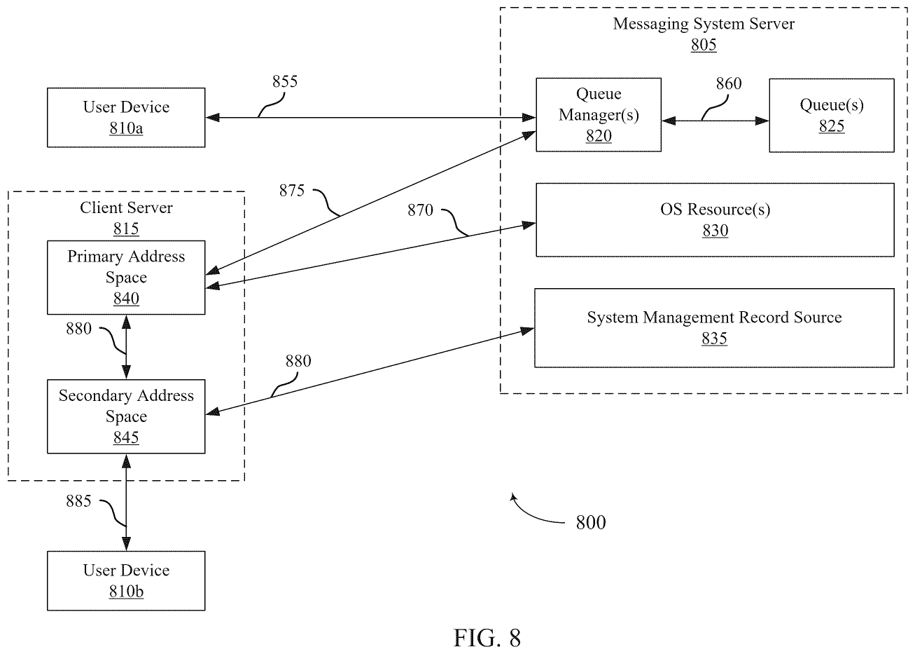

FIG. 8 is a workflow diagram of a system 800 for generating an example record summary of data related to messages in at least one message queue. The system 800 may include a messaging system server 805, one or more user devices 810a and 810b (collectively referred to as the one or more user devices 810), and a client server 815. The messaging system server 805 may be, or include aspects of, the messaging system server 105, the messaging system server 610, or the messaging system server 710 of FIGS. 1, 6, and 7, respectively. The one or more user devices 810 may be, or include aspects of, the one or more user devices 110, the one or more user devices 605, or the one or more user devices 705 of FIGS. 1, 6, and 7, respectively. The client server 815 may be, or include aspects of, the client server 115, the device 205, the client server 615, or the client server 715 of FIGS. 1, 2, 6, and 7, respectively.

The messaging system server 805 may include one or more queue managers 820, which each manage at least one queue 825. The messaging system server 805 may further include operating system resources 830 and a system management record source 835. The operating system resources 830 and/or the system management record source 835 may generate and store data associated with operation of the messaging system server 805. For example, the system management record source may store performance and accounting data related to the processing of a plurality of messages in the at least one message queue 825.

The client server 815 may include a primary address space 840 and a secondary address space 845. The primary address space 840 may be, or include aspects of, the primary address space 255, the primary address space 300, the primary address space 505, the primary address space 620, or the primary address space 720 of FIGS. 2, 3, and 5-7, respectively. The secondary address space 845 may be, or include aspects of, the secondary address space 260, the secondary address space 400, the secondary address space 510, or the secondary address space 625 of FIGS. 2 and 4-6, respectively.

The user device 810a may perform cross-application operations or communications by putting messages to, or getting messages from, the at least one message queue 825. For example, a signal 855 between the user device 810a and the one or more queue managers 820 may include information associated with the cross-application operation, such as one or more queue commands, or one or more queue response (e.g., including acknowledgements or requested data). The one or more queue managers 820 may in turn post one or more messages associated with the cross-application operation to a selected queue of the at least one queue 825. For example, a signal 860 between the one or more queue managers 820 and the at least one queue 825 may include the message data to be added to the selected queue.

The one or more queue managers 820 may select the queue for adding the message based on the cross-application operation to be performed, an application run on the user device 810a associated with the cross-application operation, or credentials (e.g., user credentials) associated with the user device 810a. For example, the user device 810a may have access to only a subset of the at least one queue 825 and/or the one or more queue managers 820. The messaging system server 805 may receive queue commands from additional devices other than the user device 810a.

At least one signal 870 between the primary address space 840 and the operating system resources 830 may include a request by the primary address space 840 for virtual storage locations of the one or more queue managers 820. For example, the primary address space 840 may request a vector table from the operating system resources 830 to locate the one or more queue managers 820 in the messaging system server 805. In response to receiving the table (e.g., via the signal 870), the primary address space 840 may automatically connect to the one or more queue managers 820. For example, at least one signal 875 between the primary address space 840 and the one or more queue managers 820 may include API calls from the primary address space 840 requesting information related to operation of the one or more queue managers 820 and the at least one queue 825, such as queue manager names, queue names, queue statistics, or the like.

In some examples, the at least one signal 870 between the operating system resources 830 and the primary address space 840 may also include location information of other components of the messaging system server, such as the system management record source 835. The primary address space 840 may route information received from the operating system resources 830 to the secondary address space 845 via one or more cross-memory calls. For example, a signal 880 between the primary address space 840 and the secondary address space 845 may include the location information of the system management record source 835. In some examples, the at least one signal 880 between the primary address space 840 and the secondary address space 845 includes information received from the one or more queue managers (e.g., via the signal 875), such as queue names, queue manager names, queue statics, or the like.

The secondary address space 845 may communicatively connect to the system management record source 835 to request system management records associated with the plurality of messages in the at least one message queue 825. For example, at least one signal 880 between the secondary address space 845 and the system management record source may include a request for the system management records by the secondary address space 845 (e.g., as a blocking get command), and may include a response to the secondary address space 845 with the system management records. In some examples, the secondary address space 845 receives tens of thousands (e.g., at least thirty thousand) records per second from the system management record source 835 via the signal 880.

The secondary address space 845 may generate at least one record summary of the data received via the signal 880 and may write the at least one record summary to a storage device. For example, at least one signal 885 between the secondary address space and the user device 810b may include the at least one record summary generated by the secondary address space 845. In some examples, the secondary address space may write the at least one record summary to the memory of another device in the system 800. For example, the at least one signal 880 between the secondary address space 845 and the system management record source 835 may include the at least one record summary. In some examples, the secondary address space 845 may store the at least one record summary within the client server 815.

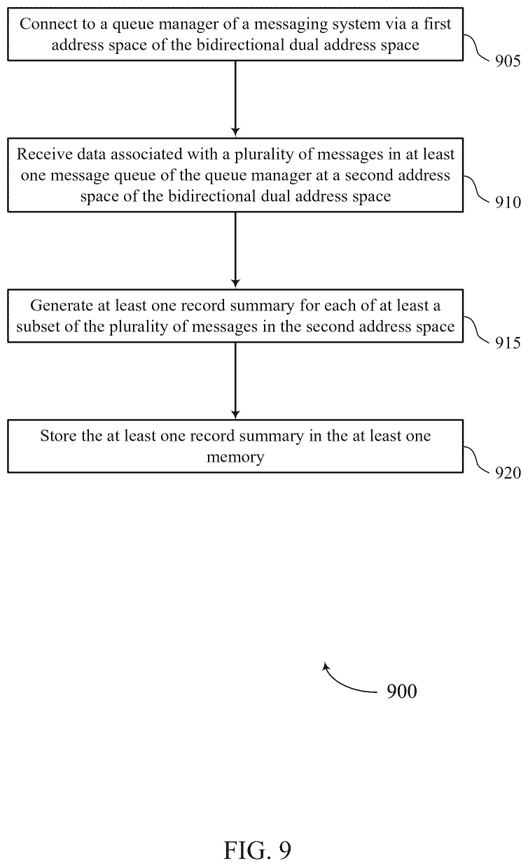

FIG. 9 is a flowchart showing an example method 900 for generating a record summary of data related to messages in at least one message queue. The method 900 may be implemented by a server or other computing system, such as the client server 115, the device 205, the client server 615, or the client server 715 of FIGS. 1, 2, 6, and 7, respectively. The method 900 may be performed using one or more processors of the server, such as the at least one processor 245 of FIG. 2, in conjunction with other components of the server or computing system, such as at least one memory. The at least one memory may be designed with a bidirectional dual address space, such as the memory 230 of FIG. 2.

At 905, the one or more processors may connect to a queue manager of a messaging system via a first address space of the bidirectional dual address space. In some examples, the one or more processors connect to the queue manager responsive to scanning a queue manager vector table for active queue managers in a virtual storage location of a messaging system.

At 910, the one or more processors receive data associated with a plurality of messages in at least one message queue of the queue manager at a second address space of the bidirectional dual address space.

In some examples, the one or more processors receive the data associated with a plurality of messages in the at least one message queue of the queue manager by connecting to an in-memory resource via the second address space. The data associated with the plurality of messages may include system performance and activity monitoring records associated with the plurality of messages. In some examples, the one or more processors output a blocking get command to the in-memory resource via the second address space to receive the system performance and activity monitoring records.

At 915, the one or more processors generate at least one record summary for each of at least a subset of the plurality of messages in the second address space.

In some examples, the at least one record summary indicates a proportion of operations performed using respective queues of the at least one message queue over a predetermined time interval. In some examples, the at least one record summary indicates a maximum CPU utilization of the at least one message queue, a minimum CPU utilization of the at least one message queue, and/or an average CPU utilization of the at least one message queue over the predetermined time interval. In some examples, the at least one record summary indicates an operation payload and resource type for the subset of the plurality of messages.

In some examples, the one or more processors extract, from respective system performance and activity monitoring records received via the second address space, at least one of a virtual storage identifier (ID) associated with the queue manager, a record source ID, a queue manager ID of the queue manager, a queue ID of the at least one message queue, an operation ID associated with the respective subset of the plurality of messages, a connection type associated with the respective subset of the plurality of messages, or combinations thereof. In some examples, the at least one record summary has a high indexing data structure. For example, indices of the high indexing data structure may correspond to at least a portion of the data extracted from the system performance and activity monitoring records.

At 920, the one or more processors store the at least one record summary in the at least one memory. An amount of data stored for the at least one record summary is less than a total amount of data associated with the plurality of messages.

In some examples, the one or more processors detect, via the first address space, an exception condition associated with the queue manager and output a notification indicating the exception condition. The exception condition may be based at least in part on at least one parameter related to the queue manager. In some examples, the exception is triggered by a message queue exceeding a utilization threshold, a channel mapping area associated with the queue manager being non-operational, or both.

In some examples, the one or more processors process statistical data of the system performance and activity monitoring records via the second address space, and generate an alert based on the statistical data.

The various illustrative blocks and components described in connection with the disclosure herein may be implemented or performed using a general-purpose processor, a Digital Signal Processing device (DSP), an ASIC, a Central Processing Unit (CPU), a graphics processing unit (GPU), a neural processing unit (NPU), a Field Programmable Gate Array (FPGA) or other PLD, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by multiple processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, controllers, firmware, hardwiring, circuitry, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include random access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, the software may be transmitted from a website, server, or other remote source using a wired technology such as a coaxial cable, fiber optic cable, twisted pair, digital subscriber line (DSL), universal serial bus (USB), high-definition multimedia interface (HDMI), video graphics array (VGA), digital visual interface (DVI), thunderbolt cable, power cable, ribbon cable, integrated services digital network (ISDN), or wireless technologies such as wireless fidelity (Wi-Fi), Bluetooth, cellular network, near-field communication (NFC), Zigbee, long range (LoRa), infrared (IR), radio frequency identification (RFID), light fidelity (Li-Fi), satellite, ultra-wideband (UWB), millimeter wave (mmWave), and microwave. The wired and or wireless technologies are included in the definition of computer-readable medium. Disk and disc, as used herein, include a compact disk (CD), laser disc, optical disc, digital versatile disc (DVD), floppy disk, and Blu-ray disc. Disks or discs may reproduce data magnetically or optically using lasers. Combinations of the above are also included within the scope of computer-readable media. Any functions or operations described herein as being capable of being performed by a memory may be performed by multiple memories that, individually or collectively, are capable of performing the described functions or operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

Machine learning includes one or more systems that may be adapted to generate, train, and execute one or more trained learning models, nodes, neural networks, gradient boosting algorithms, mutual information classifiers, random forest classifications, and other machine learning and artificial intelligence-based algorithms or models to process inputs, parameters, and other data elements. In some examples, the one or more trained learning models can include deep learning, machine learning, neural networks, computer vision, and similar advanced artificial intelligence-based technologies. In some examples, the machine learning or artificial intelligence may use additional inputs and/or feedback loops to an iterative training process for enhanced data processing and improved outcomes.

Although the disclosure may describe components and functions that may be implemented in a particular example with reference to a particular standard or protocol, the disclosure is not limited to the standard or protocol. Other standards or protocols supporting similar functionality are considered equivalents thereof.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Furthermore, “and/or” as used in a list of items indicates an inclusive list such that, for example, a list of at least one of A, B, and/or C means A or B or C or AB or AC or BC or ABC (i.e., A and B and C). Also, as used herein, the phrase “based on” shall not be construed as a reference to a closed set of conditions. For example, an example step that may be described as “based on condition A” may be based on both a condition A and a condition B. For example, as used herein, the phrase “based on” shall be construed in the same manner as the phrase “based at least in part on.”

As used herein, including in the claims, the article “a” before a noun may be open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The terms “determine,” “determining,” “identify,” or “identifying” encompasses a variety of actions and, therefore, “determining” or “identifying” can include calculating, computing, processing, deriving, investigating, looking up (such as via looking up in a table, a database, or another data structure), receiving, ascertaining, and the like. Also, “determining” or “identifying” can include receiving (for example, receiving information), accessing (for example, accessing data stored in memory), retrieving, and the like. Also, “determining” or “identifying” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label may be used in the specification, the description may be applicable to any one of the similar components having the same first reference label irrespective of the second reference label or other subsequent reference label.

The description set forth herein, in connection with the appended figures, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples. The features of the various examples described herein may be combined in any suitable manner. It is contemplated that one or more features from one example may be incorporated into another example unless explicitly stated otherwise. The combinations of features from different examples are within the scope of the disclosure.

It will be appreciated by those skilled in the art that while the disclosure has been described above in connection with particular examples, the disclosure is not necessarily so limited, and that numerous other examples, uses, means for, modifications and departures from the examples, uses, and means for are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A system, comprising:
at least one memory designed with a bidirectional dual address space and storing processor-executable code; and
at least one processor in communication with the at least one memory, the at least one processor designed to execute the code to cause the system to:
connect to a queue manager of a messaging system via a first address space of the bidirectional dual address space;
receive data associated with a plurality of messages in at least one message queue of the queue manager at a second address space of the bidirectional dual address space;
generate at least one record summary for each of at least a subset of the plurality of messages in the second address space; and
store the at least one record summary in the at least one memory, wherein an amount of data stored for the at least one record summary is less than a total amount of data associated with the plurality of messages.

2. The system of claim 1, wherein the at least one processor is further designed to execute the code to cause the system to:
generate the at least one record summary such that the at least one record summary indicates a proportion of operations performed using respective queues of the at least one message queue over a predetermined time interval.

3. The system of claim 2, wherein the at least one record summary further indicates at least one of a maximum computer processing unit (CPU) utilization of the at least one message queue, a minimum CPU utilization of the at least one message queue, an average CPU utilization of the at least one message queue over the predetermined time interval, or combinations thereof.

4. The system of claim 1, wherein the at least one processor is designed to execute the code to cause the system to receive the data associated with a plurality of messages in the at least one message queue of the queue manager by connecting to an in-memory resource via the second address space, wherein the data associated with the plurality of messages includes system performance and activity monitoring records associated with the plurality of messages.

5. The system of claim 1, wherein the at least one processor designed to execute the code to cause the system to generate the at least one record summary for a respective subset of the plurality of messages is further designed to:
extract, from respective system performance and activity monitoring records received via the second address space, at least one of a virtual storage identifier (ID) associated with the queue manager, a record source ID, a queue manager ID of the queue manager, a queue ID of the at least one message queue, an operation ID associated with the respective subset of the plurality of messages, a connection type associated with the respective subset of the plurality of messages, or combinations thereof.

6. The system of claim 1, wherein the at least one record summary has a non-linear high indexing data structure.

7. The system of claim 6, wherein the at least one processor is further designed to execute the code to cause the system to:
detect, via the first address space, an exception condition associated with the queue manager, wherein the exception condition is based at least in part on at least one parameter related to the queue manager; and
output a notification indicating the exception condition.

8. The system of claim 1, wherein the at least one processor is further designed to execute the code to cause the system to:
scan a queue manager vector table for active queue managers in a virtual storage location.

9. The system of claim 1, wherein the at least one record summary indicates an operation payload and resource type for the subset of the plurality of messages.

10. A method, comprising:
connecting to a queue manager of a messaging system via a first address space of a bidirectional dual address space of a memory;
receiving data associated with a plurality of messages in at least one message queue of the queue manager at a second address space of the bidirectional dual address space of the memory; and
storing at least one record summary each for at least a subset of the plurality of messages in the second address space, wherein an amount of data stored for the at least one record summary is less than a total amount of data associated.

11. The method of claim 10, further comprising:
detecting, via the first address space, an exception condition associated with the queue manager, wherein the exception condition is based at least in part on at least one parameter related to the queue manager; and
outputting a notification indicating the exception condition.

12. The method of claim 11, wherein the exception condition is triggered by at least one of the at least one message queue exceeding a utilization threshold, at least one channel mapping area associated with the queue manager being non-operational, or combinations thereof.

13. The method of claim 10, further comprising:
connecting to an in-memory resource via the second address space to receive the data associated with the plurality of messages in the at least one message queue of the queue manager, wherein the data associated with the plurality of messages in the at least one message queue of the queue manager includes system performance and activity monitoring records associated with the plurality of messages.

14. The method of claim 13, further comprising:
outputting at least one blocking get command to the in-memory resource via the second address space to receive the system performance and activity monitoring records.

15. The method of claim 13, further comprising:
processing statistical data of the system performance and activity monitoring records via the second address space; and
generating an alert based on the statistical data of the system performance and activity monitoring records.

16. The method of claim 15, further comprising:
extracting, from respective system performance and activity monitoring records received via the second address space, at least one of a virtual storage identifier (ID) associated with the queue manager, a record source ID, a queue manager ID of the queue manager, a queue ID of the at least one message queue, an operation ID associated with the respective subset of the plurality of messages, a connection type associated with the respective subset of the plurality of messages, or a combination thereof.

17. The method of claim 16, further comprising:
generating the at least one record summary using data extracted from the system performance and activity monitoring records over a predetermined time interval.

18. The method of claim 10, wherein connecting to the queue manager via the first address space includes scanning, in a virtual storage location, a queue manager vector table for active queue managers.

19. The method of claim 10, wherein the at least one record summary has a non-linear high indexing data structure.

20. One or more non-transitory computer-readable storage media including instructions that, when executed by one or more processors, cause the one or more processors to perform a set of operations comprising:
connecting to a queue manager of a messaging system via a first address space of a bidirectional dual address space of a memory;
receiving data associated with a plurality of messages in at least one message queue of the queue manager at a second address space of the bidirectional dual address space of the memory; and
storing at least one record summary each for at least a subset of the plurality of messages in the second address space, wherein an amount of data stored for the at least one record summary is less than a total amount of data associated.
